(19) United States
(12) Patent Application Publication
(10) Pub. No.: US 2015/0118438 A1
(43) Pub. Date: Apr. 30, 2015

(54) INSULATING MATERIALS AND METHODS OF FORMING SAME

(71) Applicant: Mountain Hardwear, Inc., Portland, OR (US)

(72) Inventors: Steven Yui, Richmond, CA (US); Helen Li, Richmond, CA (US)

(21) Appl. No.: 14/525,074

(22) Filed: Oct. 27, 2014

Related U.S. Application Data
(60) Provisional application No. 61/895,574, filed on Oct. 25, 2013.

(51) Int. Cl. A41D 31/02; B32B 3/28; B32B 3/06; D05B 1/02; B32B 7/12; B32B 7/04; B32B 37/00; B32B 38/00; B32B 1/00; B32B 7/08

(52) U.S. Cl. CPC A41D 31/02; B32B 1/00; B32B 3/28; B32B 3/06; B32B 7/08; B32B 7/12; B32B 7/045; B32B 37/0076; B32B 38/0012; D05B 1/02; B32B 2038/0028; B32B 2250/03; B32B 2305/38; B32B 2307/304; B32B 2437/02; A41D 2400/10; A41D 2300/52; A41D 2500/30
USPC 428/101; 156/164; 112/475.09; 2/458

(57) ABSTRACT

Embodiments of insulation materials, and methods of their formation, are disclosed herein. In some embodiments, an insulating material may include a stretchable scrim layer, a face layer, and an insulation layer disposed between the scrim layer and the face layer. First and second seams may couple the stretchable scrim layer, the insulation layer, and the face layer, and a length of the face material between the first and second seams is greater than a length of the stretchable scrim between the first and second seams. Other embodiments may be disclosed and/or claimed.

### CROSS-REFERENCE TO RELATED APPLICATION

This application claims priority to U.S. Provisional Patent Application No. 61/895,574, filed Oct. 25, 2013, and titled “INSULATING MATERIALS AND METHODS OF FORMING SAME,” the entire contents of which are incorporated by reference herein.

### BACKGROUND

Some existing insulating materials attempt to trap warm air close to a user's or wearer's body using insulated baffles. These materials often exhibit “cold spots” around baffle seams, and existing construction techniques limit the height and shape of baffles that can be efficiently manufactured.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIGS. 1A and 1B are perspective and exploded cross-sectional views, respectively, of an insulating material, in accordance with some embodiments.

FIGS. 2A-2J depict the insulating material of FIG. 1 in various stages of formation, in accordance with some embodiments.

FIG. 3 is a flow diagram illustrating a process for forming an insulating material, in accordance with some embodiments.

### DETAILED DESCRIPTION

Embodiments of insulation materials, and methods of their formation, are disclosed herein. In some embodiments, an insulating material may include a stretchable scrim layer, a face layer, and an insulation layer disposed between the scrim layer and the face layer. First and second seams may couple the stretchable scrim layer, the insulation layer, and the face layer, and a length of the face material between the first and second seams is greater than a length of the stretchable scrim between the first and second seams.

In the following detailed description, reference is made to the accompanying drawings that form a part hereof wherein like numerals designate like parts throughout, and in which is shown by way of illustration embodiments that may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

Various operations may be described as multiple discrete actions or operations in turn, in a manner that is most helpful in understanding the disclosed embodiments. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B, and C).

The description uses the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

The description may use perspective-based descriptions such as up/down, back/front, top/bottom, and outer/inner. Such descriptions are merely used to facilitate the discussion and are not intended to restrict the application of disclosed embodiments.

The terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical contact. However, “coupled” may also mean that two or more elements are not in direct contact with each other, but yet still cooperate or interact with each other.

With respect to the use of any plural and/or singular terms herein, those having skill in the art can translate from the plural to the singular and/or from the singular to the plural as is appropriate to the context and/or application. The various singular/plural permutations may be expressly set forth herein for sake of clarity.

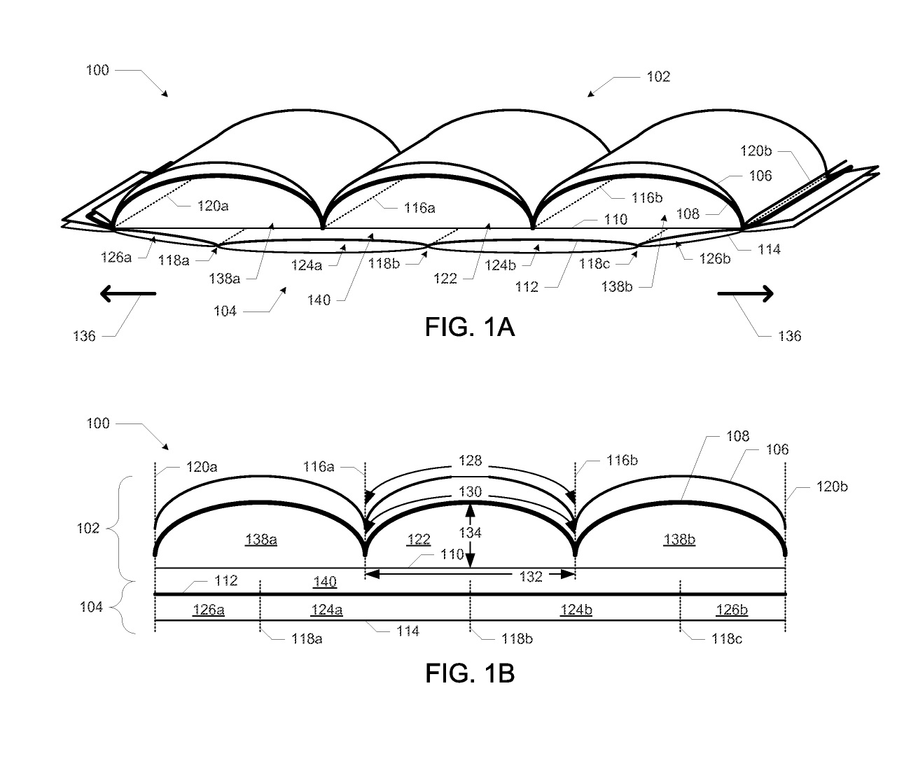

FIGS. 1A and 1B are various views of an insulating material 100, in accordance with some embodiments. The insulating material 100 may include an outer layer 102 and an inner layer 104. As noted above, the terms “outer” and “inner” are used to facilitate the discussion of the insulating material 100 and do not restrict the use of the insulating material 100; for example, a jacket may be formed from the insulating material 100, having the outer layer 102 disposed between the wearer's body and the inner layer 104. FIGS. 1A-3 depict portions of insulating materials including a limited number of baffles for clarity of illustration; insulating materials with more than the illustrated numbers of baffles are expressly contemplated, and may be formed by simple extension of the techniques disclosed herein.

The outer layer 102 may include a face layer 106, an insulation layer 108, and a scrim layer 110. In some embodiments, the face layer 106 may include one or more materials typically used in garments or equipment, such as nylon, polyester, polypropylene, waterproof, breathable materials, wovens, knits, and non-woven garment materials, among others. In some embodiments, the insulation layer 108 may include one or more continuous insulation materials, such as wool, aerogel, flannel, synthetic insulations, and OMNI-HEAT reflective fabrics, among others. Scrim layer 110 may include one or more continuous stabilizing materials, such as nylon, polyester, OMNI-HEAT reflective fabrics, wovens, or knits, for example.

In some embodiments, the scrim layer 110 may be stretchable. As used herein, the term “stretchable” may refer to the ability to elongate when tension is applied in at least one direction and to retract when tension is removed. In some embodiments, the scrim layer 110 may be elastic or substantially elastic, and may fully or substantially retract when tension is removed to return to its original shape. The scrim layer 110 may be stretchable in one direction, two directions, or more directions. In some embodiments, a stretchable scrim layer 110 may be formed from a combination of stretchable and non-stretchable materials; for example, the scrim layer 110 may be formed from adjacent patches of stretchable material (e.g., elastic) and non-stretchable material. In some embodiments, the scrim layer 110 may not be stretchable.

The “stretchability” of the scrim layer 110 may depend on the desired baffle dimensions. For example, a scrim layer 110 that is more stretchable may be needed for baffles with a higher ratio of baffle height to baffle width. In some embodiments, the scrim layer 110 may be sufficiently stretchable so as to achieve an increase of greater than approximately 30% in a given dimension when sufficient tension is applied along that dimension. For example, in some embodiments, the scrim layer 110 may be sufficiently stretchable so as to achieve a 50-60% increase in a given dimension when sufficient tension is applied along that dimension. This stretchability may be adequate to form a baffle having a height of approximately 0.5 inches and a width of approximately 1 inch, for example. In some embodiments, the scrim layer 110 may be sufficiently stretchable so as to achieve an increase of greater than approximately 10% in a given dimension when sufficient tension is applied along that dimension. In some embodiments, the scrim layer 110 may be sufficiently stretchable so as to achieve a 10-20% increase in a given dimension when sufficient tension is applied along that dimension. This stretchability may be adequate to form a baffle having a height of approximately 0.5 inches and a width of approximately 3 inches, or a height of approximately 0.25 inches and a width of approximately 1 inch, for example.

The outer layer 102 may include a seam 116a and a seam 116b. The seam 116a may couple the scrim layer 110, the insulation layer 108, and the face layer 106. The seam 116b may also couple the scrim layer 110, the insulation layer 108, and the face layer 106. In some embodiments, the seams 116 may be spaced apart by three inches of the scrim layer 110. In some embodiments, the seams 116a and/or 116b may be spaced apart by 1, 2, 4, 6, or 8 inches, for example. In some embodiments, the seams 116a and 116b may be parallel. The seams 116a, 116b, and any of the seams discussed herein, may include a stitched seam, a glued seam, a welded seam, or a combination of such seams, for example.

A baffle 122 may be formed between the seam 116a, the seam 116b, the scrim layer 110, and the insulation layer 108. In some embodiments, the baffle 122 may be filled with down plumes or feathers, aerogel, wool, flannel, or any other insulating fill. In some embodiments, the baffle 122 may be filled with air. In some embodiments, the baffle 122 may have a height 134 greater than approximately 0.25 inches.

A length 128 of the face layer 106 between the seams 116a, b may be greater than a length 132 of the scrim layer 110 between the seams 116a, b, causing the face layer 106 to “bubble up” from the scrim layer 110 in the region of the baffle 122. Similarly, a length 130 of the insulation layer 108 between the seams 116a, b may be greater than a length 132 of the scrim layer 110 between the seams 116a, b. In some embodiments, the length 128 and the length 130 may be approximately equal. The arrangement illustrated in FIGS. 1A and 1B may advantageously trap air in the space between baffles, which may be heated by the body and retained in the baffle space to improve heat retention and clothing insulation value (CLO).

The discussion above regarding the relative lengths of various layers between seams 116a, b may apply to the insulating material 100 when the scrim layer 110 is not under tension. In embodiments in which the scrim layer 110 is stretchable, when tension is applied to the scrim layer 110 in the plane of the scrim layer 110, the scrim layer 110 may elongate. In particular, when tension is applied in the plane of the scrim layer 110, and perpendicular to at least one of the seams 116a, b (e.g., in the direction of the arrows 136), the length 128 of the face layer 106 between the seams 116a, b may be approximately equal to a length of the scrim layer 110 between the seams 116a, b.

The insulating material 100 may include an inner layer 104. The inner layer 104 may include an insulation layer 112 and a lining layer 114. The insulation layer 112 and the lining layer 114 may be formed from any of the materials discussed above with reference to the face layer 106 and the insulation layer 108. The material or materials used in the insulation layer 112 may be different from or the same as the material or materials used in the insulation layer 108.

A seam 118b may couple the insulation layer 112 and the lining layer 114. In some embodiments, the seam 118b may be disposed below the baffle 122 formed by the scrim layer 110, the insulation layer 108, and the seams 116a, b. Additional seams 118a and 118c may couple the insulation layer 112 and the lining layer 114. The seams 118a-c may form two baffles 124a and 124b in the inner layer 104 (i.e., between adjacent pairs of seams, the lining layer 114 and the insulation layer 112). The seams 118a-c may be offset from the seams 116a, b. Offsetting the seams 118a-c from the seams 116a and/or 116b may avoid or mitigate the problem of “stitch line cold spots” (in which insulating material migrates away from seams) by arranging additional insulation and other material at the potential stitch/seam cold spot.

A seam 120a may couple the outer layer 102 to the inner layer 104. In particular, the seam 120a may couple the insulation layer 112 and the lining layer 114 to the scrim layer 110, the face layer 106, and the insulation layer 108. A seam 120b may also couple the outer layer 102 to the inner layer 104, as described above with reference to the seam 120a.

The seams 120a and 120b may form additional baffles in the insulating material 100. For example, a baffle 138a may be formed in the outer layer 102 between the seam 120a, the seam 116a, the scrim layer 110, and the insulation layer 108. A baffle 138b may be formed in the outer layer 102 between the seam 120b, the seam 116b, the scrim layer 110, and the insulation layer 108. A baffle 126a may be formed in the inner layer 104 between the seam 120a, the seam 118a, the lining layer 114, and the insulation layer 112. A baffle 126b may be formed in the inner layer 104 between the seam 120b, the seam 118c, the lining layer 114, and the insulation layer 112. Also, a baffle 140 may be formed between the seams 120a and 120b, the inner layer 104, and the outer layer 102.

Although particular numbers and arrangements of baffles are illustrated in FIGS. 1A and 1B, any number of baffles may be included in the insulating material 100 by using any desired lengths of the inner layer 104 and the outer layer 102 between the seams 120a and 120b. In particular, the inner layer 104 and the outer layer 102 may be constructed separately, each having any desired number of baffles constructed as discussed herein, and then the inner layer 104 and the outer layer 102 may be coupled together in any desired manner (e.g., via seams 120a and 120b).

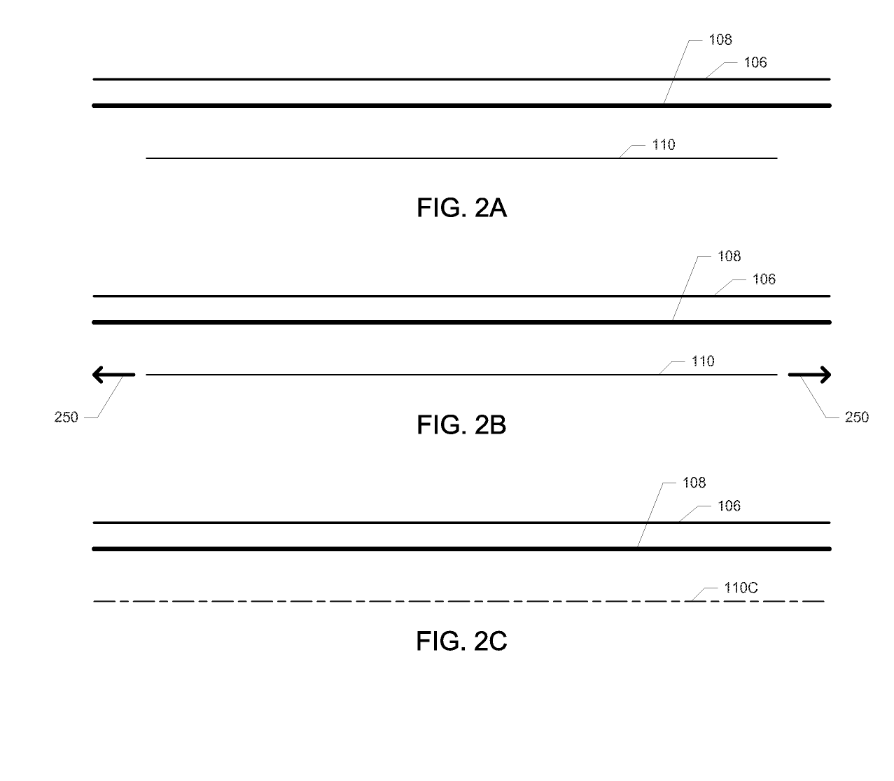

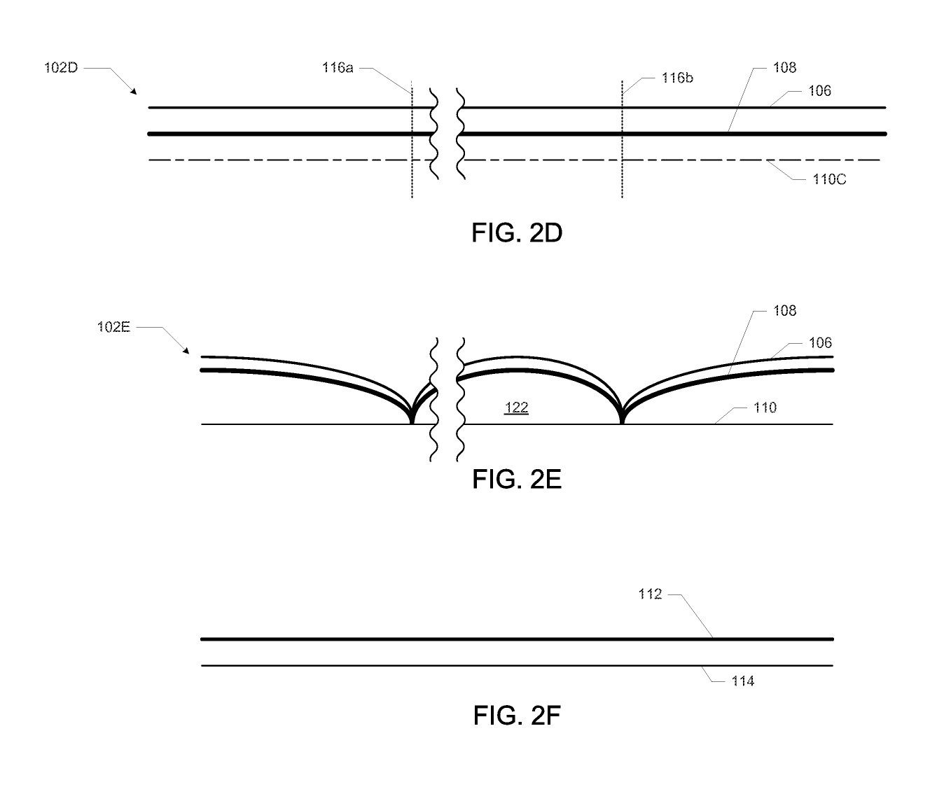

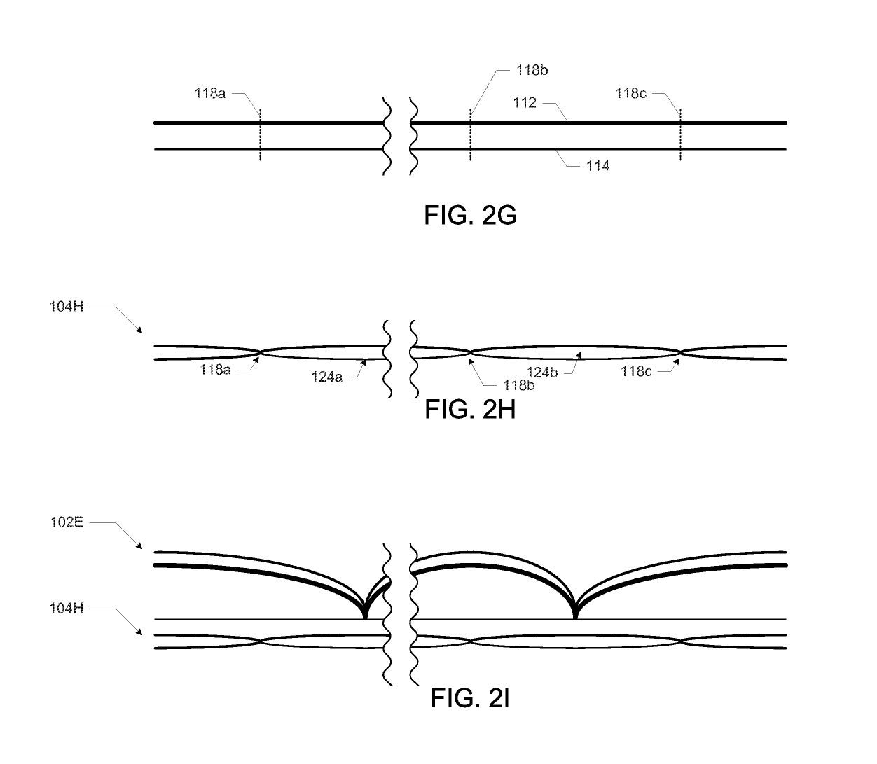

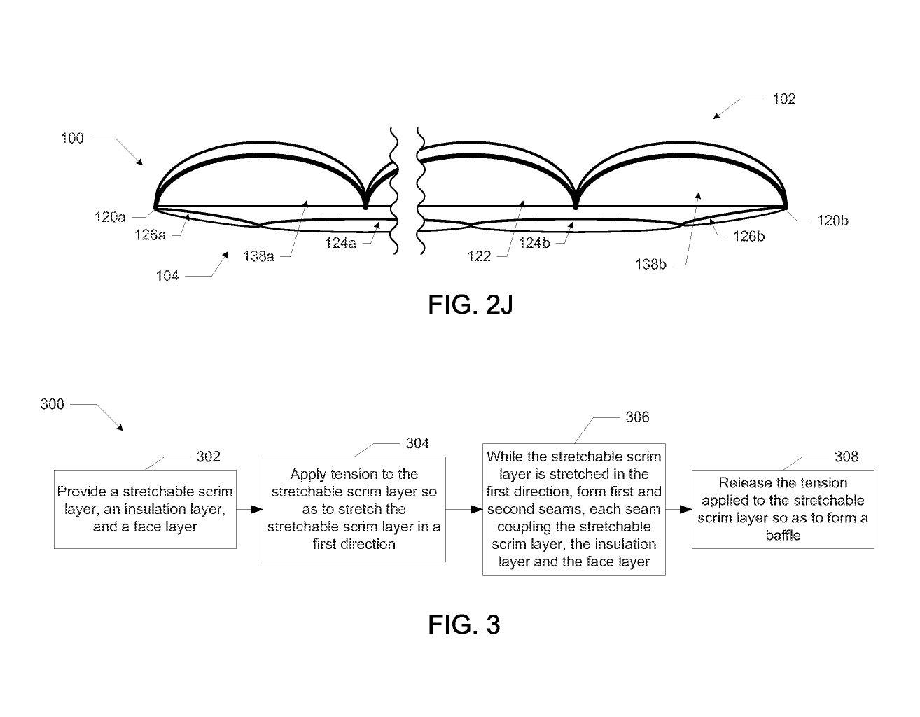

FIGS. 2A-2J depict the insulating material 100 of FIGS. 1A and 1B in various stages of formation, in accordance with some embodiments. As noted above, while the stages of formation illustrated in FIGS. 2A-2J are arranged in a particular order and illustrated once each, in various embodiments, one or more of the stages may be repeated, omitted, or performed out of order. Any of the stages of formation illustrated in FIGS. 2A-2J may be performed in accordance with any of the embodiments of the insulating material 100, or any other insulating material, described herein.

In FIG. 2A, material to form the outer layer 102 is provided. In particular, material to form the face layer 106, the insulation layer 108, and the scrim layer 110 is provided. As illustrated in FIG. 2A, the length of the material provided for the scrim layer 110 may be less than the length of the material provided for the face layer 106 and/or the insulation layer 108. In some embodiments, as discussed above, the scrim layer 110 may be stretchable.

In FIG. 2B, a force may be applied to the scrim layer 110 in the direction of the arrows 250 to tension the scrim layer 110. The force may be applied by, for example, anchoring one end of the scrim layer 110 while pulling the other end of the scrim layer 110 away, thereby tensioning the scrim layer 110.

In FIG. 2C, the scrim layer 110 is shown when stretched under tension (using a dashed-dotted line 110C). In some embodiments, the scrim layer 110 may be stretched so as to have a desired length (e.g., a length equal to the length of the insulation layer 108 and/or the face layer 106).

In FIG. 2D, the seams 116a, b are formed to couple the face layer 106, the insulation layer 108, and the scrim layer 110 into an assembly 102D. The seams 116a, b may be formed while the scrim layer 110 is under tension. FIG. 2D includes break lines to indicate that any desired number of seams like seams 116a, b may be included in assembly 102D.

In FIG. 2E, assembly 102E is formed by releasing the tension on the scrim layer 110. As shown, the scrim layer 110 may resume or substantially resume its initial length, causing the insulation layer 108 and the face layer 106 to protrude away from the scrim layer 110 around the baffle 122. FIG. 2E includes break lines to indicate that any desired number of baffles like the baffle 122 may be included in the assembly 102E by including additional seams like seams 116a, b.

In FIG. 2F, material to form the inner layer 104 is provided. In particular, material to form the insulation layer 112 and the lining layer 114 is provided. The components of the outer layer 102 are not illustrated in FIGS. 2F-2H to simplify the drawings.

In FIG. 2G, the seams 118a-c are formed to couple the insulation layer 112 and the lining layer 114. FIG. 2G includes break lines to indicate that any desired number of seams like the seams 118a-c may be included when coupling the insulation layer 112 and the lining layer 114.

In FIG. 2H, the assembly 104H is illustrated, showing the baffles 124a and 124b formed by the seams 118a-c, the insulation layer 112, and the lining layer 114. FIG. 2H includes break lines to indicate that any desired number of baffles like the baffles 124a, b may be included in the assembly 104H by including additional seams like the seams 118a-c.

In FIG. 21, the assembly 102E (FIG. 2E) and the assembly 104H (FIG. 2H) are provided. The assembly 102E may form the outer layer 102, while the assembly 104H may form the inner layer 104.

In FIG. 2J, the seams 120a and/or 120b are formed to couple the outer layer 102 to the inner layer 104, thereby forming the insulating material 100. As discussed above, the seams 120a and/or 120b may form additional baffles in the insulating material 100; namely, the baffles 138a, 138b, 126a, and 126b.

FIG. 3 is a flow diagram illustrating a process 300 for forming an insulating material (e.g., the insulating material 100 of FIGS. 1A and 1B), in accordance with some embodiments. As noted above, while the operations of the process 300 are arranged in a particular order and illustrated once each, in various embodiments, one or more of the operations may be repeated, omitted, or performed out of order. Any of the operations of the process 300 may be performed in accordance with any of the embodiments of the insulating material 100, or any other insulating material, described herein.

The process 300 may begin at the operation 302, in which a stretchable scrim layer (e.g., the scrim layer 110), an insulation layer (e.g., the insulation layer 108), and a face layer (e.g., the face layer 106) may be provided. In some embodiments, the insulation layer may be disposed between the stretchable scrim layer and the face layer.

At the operation 304, tension may be applied to the stretchable scrim layer so as to stretch the stretchable scrim layer in a first direction (e.g., the direction 136).

At the operation 306, while the stretchable scrim layer is stretched in the first direction, first and second seams (e.g., the seams 116a and 116b) may be formed, each coupling the stretchable scrim layer, the insulation layer, and the face layer. In some embodiments, neither of the first and second seams is parallel to the first direction.

At the operation 308, the tension in the stretchable scrim layer may be released, forming a baffle (e.g., the baffle 122) between the first and second seams, the stretchable scrim layer, and the insulation layer.

The insulating materials disclosed herein may be included in any of a number of products, such as apparel (such as jackets, pants, gloves, hats), footwear (such as shoes and boots), or equipment (such as sleeping bags, blankets, tents), or any other insulating product. For example, a garment may include multiple baffles in and between inner and outer layers defined by seams in accordance with any of the embodiments discussed herein. In some embodiments, particular arrangements of insulation and baffle dimensions may be selected for different thermal performance in different portions of a product. For example, additional insulation may be included in a portion of the garment where more warmth is desired.

The insulating materials described herein (e.g., as depicted in the figures) are simply illustrative, and additional insulating materials within the present disclosure include stacks of one or more of the depicted insulating materials, side-by-side combinations of one or more of the depicted insulating materials, overlapping combinations of one or more of the depicted insulating materials, or any other combination of the depicted insulating material. Any of the materials disclosed herein for the face layer, the lining layer, the insulation layers, and the scrim layer for any particular embodiment may be used in any combination in any other embodiment of the insulating material.

Although certain embodiments have been illustrated and described herein, it will be appreciated by those of ordinary skill in the art that a wide variety of alternate and/or equivalent embodiments or implementations calculated to achieve the same purposes may be substituted for the embodiments shown and described without departing from the scope. Those with skill in the art will readily appreciate that embodiments may be implemented in a very wide variety of ways. This application is intended to cover any adaptations or variations of the embodiments discussed herein.

The following paragraphs provide examples of various ones of the embodiments disclosed herein.

Example 1 is an insulating material, including: a stretchable scrim layer; a face layer; an insulation layer disposed between the scrim layer and the face layer; and first and second seams coupling the stretchable scrim layer, the insulation layer, and the face layer, wherein a length of the face material between the first and second seams is greater than a length of the stretchable scrim layer between the first and second seams.

Example 2 may include the subject matter of Example 1, and may further specify that a length of the face material between the first and second seams is approximately equal to a length of the stretchable scrim layer between the two seams when the stretchable scrim layer is under tension in a plane of the stretchable scrim layer and perpendicular to at least one seam.

Example 3 may include the subject matter of Example 2, and may further specify that the length of the stretchable scrim layer between the first and second seams is approximately three inches.

Example 4 may include the subject matter of any of Examples 1-3, and may further specify that a length of the insulation layer between the first and second seams is greater than a length of the stretchable scrim layer between the first and second seams when the stretchable scrim layer is not under tension.

Example 5 may include the subject matter of any of Examples 1-4, and may further specify that a baffle is formed between the insulation layer and the stretchable scrim layer.

Example 6 may include the subject matter of Example 5, and may further specify that a height of the baffle is greater than approximately 0.25 inches.

Example 7 may include the subject matter of any of Examples 1-6, and may further specify that the first and second seams are parallel.

Example 8 may include the subject matter of any of Examples 1-7, and may further include: a second insulation layer; a lining layer; a third seam coupling the second insulation layer and the lining layer, the third seam disposed below a baffle formed by the stretchable scrim layer, the insulation layer, and the first and second seams; and a fourth seam coupling the second insulation layer and the lining layer to the stretchable scrim layer, the face layer, and the insulation layer.

Example 9 may include the subject matter of any of Examples 1-8, and may further specify that the insulating material is included in apparel, footwear, or equipment.

Example 10 may include the subject matter of any of Examples 1-9, and may further specify that at least one of the first and second seams include a stitched seam.

Example 11 may include the subject matter of any of Examples 1-10, and may further specify that at least one of the first and second seams include a glued seam.

Example 12 may include the subject matter of any of Examples 1-11, and may further specify that at least one of the first and second seams include a welded seam.

Example 13 is a method of forming an insulating material including: providing a stretchable scrim layer, an insulation layer, and a face layer, wherein the insulation layer is disposed between the stretchable scrim layer and the face layer; applying tension to the stretchable scrim layer so as to stretch the stretchable scrim layer in a first direction; while the stretchable scrim layer is stretched in the first direction, forming first and second seams, each seam coupling the stretchable scrim layer, the insulation layer, and the face layer, wherein the first and second seams are not parallel to the first direction and wherein the first and second seams are spaced apart in the first direction; and releasing the tension applied to the stretchable scrim layer so as to form a baffle, the baffle extending between the stretchable scrim layer and the insulation layer and between the first and second seams.

Example 14 may include the subject matter of Example 13, and may further specify that a length of the stretchable scrim between the first and second seams is approximately three inches.

Example 15 may include the subject matter of any of Examples 13-14, and may further specify that a height of the baffle is greater than approximately 0.25 inches.

Example 16 may include the subject matter of any of Examples 13-15, and may further specify that the first and second seams are parallel.

Example 17 may include the subject matter of any of Examples 13-16, and may further specify that forming the first and second seams includes forming a stitched seam.

Example 18 may include the subject matter of any of Examples 13-16, and may further specify that forming the first and second seams includes forming a glued seam.

Example 19 may include the subject matter of any of Examples 13-16, and may further specify that forming the first and second seams includes forming a welded seam.

Example 20 is a garment including the insulating material of any of Examples 1-12.

Example 21 is a method of forming a garment including performing the method of any of Examples 13-19.

What is claimed is:

1. An insulating material, comprising:
a stretchable scrim layer;
a face layer;
an insulation layer disposed between the scrim layer and the face layer; and
first and second seams coupling the stretchable scrim layer, the insulation layer, and the face layer, wherein a length of the face material between the first and second seams is greater than a length of the stretchable scrim layer between the first and second seams.

2. The insulating material of claim 1, wherein a length of the face material between the first and second seams is approximately equal to a length of the stretchable scrim layer between the two seams when the stretchable scrim layer is under tension in a plane of the stretchable scrim layer and perpendicular to at least one seam.

3. The insulating material of claim 2, wherein the length of the stretchable scrim layer between the first and second seams is approximately three inches.

4. The insulating material of claim 1, wherein a length of the insulation layer between the first and second seams is greater than a length of the stretchable scrim layer between the first and second seams when the stretchable scrim layer is not under tension.

5. The insulating material of claim 1, wherein a baffle is formed between the insulation layer and the stretchable scrim layer.

6. The insulating material of claim 5, wherein a height of the baffle is greater than approximately 0.25 inches.

7. The insulating material of claim 1, wherein the first and second seams are parallel.

8. The insulating material of claim 1, further comprising:
a second insulation layer;
a lining layer;
a third seam coupling the second insulation layer and the lining layer, the third seam disposed below a baffle formed by the stretchable scrim layer, the insulation layer, and the first and second seams; and
a fourth seam coupling the second insulation layer and the lining layer to the stretchable scrim layer, the face layer, and the insulation layer.

9. The insulating material of claim 1, wherein the insulating material is included in apparel, footwear, or equipment.

10. The insulating material of claim 1, wherein at least one of the first and second seams comprise a stitched seam.

11. The insulating material of claim 1, wherein at least one of the first and second seams comprise a glued seam.

12. The insulating material of claim 1, wherein at least one of the first and second seams comprise a welded seam.

13. A method of forming an insulating material comprising:
providing a stretchable scrim layer, an insulation layer, and a face layer, wherein the insulation layer is disposed between the stretchable scrim layer and the face layer;
applying tension to the stretchable scrim layer so as to stretch the stretchable scrim layer in a first direction;
while the stretchable scrim layer is stretched in the first direction, forming first and second seams, each seam coupling the stretchable scrim layer, the insulation layer, and the face layer, wherein the first and second seams are not parallel to the first direction and wherein the first and second seams are spaced apart in the first direction; and
releasing the tension applied to the stretchable scrim layer so as to form a baffle, the baffle extending between the stretchable scrim layer and the insulation layer and between the first and second seams.

14. The method of claim 13, wherein a length of the stretchable scrim between the first and second seams is approximately three inches.

15. The method of claim 13, wherein a height of the baffle is greater than approximately 0.25 inches.

16. The method of claim 13, wherein the first and second seams are parallel.

17. The method of claim 13, wherein forming the first and second seams comprises forming a stitched seam.

18. The method of claim 13, wherein forming the first and second seams comprises forming a glued seam.

19. The method of claim 13, wherein forming the first and second seams comprises forming a welded seam.
